(19) United States
(12) Patent Application Publication
(10) Pub. No.: US 2026/0208709 A1
(43) Pub. Date: Jul. 23, 2026

(54) Method and Device for Controlling Braking Force of a Vehicle

(71) Applicant: Robert Bosch GmbH, Stuttgart (DE)

(72) Inventors: Robert Schmidt, Ludwigsburg (DE); Christian Kaiser, Stuttgart (DE); Patrick Ruck, Stuttgart (DE)

(21) Appl. No.: 19/452,695

(22) Filed: Jan. 19, 2026

(30) Foreign Application Priority Data
Jan. 20, 2025 (DE) 10 2025 101 804.9

(51) Int. Cl. B60T 8/172; B60T 7/12; B60T 8/171; B60T 8/24

(52) U.S. Cl. CPC B60T 8/172; B60T 7/122; B60T 8/171; B60T 8/245; B60T 2201/04; B60T 2210/20; B60T 2220/06; B60T 2250/00

(57) ABSTRACT

A method and device for controlling brake-force distribution between a first and a second brake arrangement of a vehicle is disclosed. In this context, a pedal variable representing actuation of the accelerator pedal is detected. Furthermore, a drive variable is detected, which represents the driving force of the engine. In order to determine the extent to which establishment of a holding force for the vehicle is required, or the magnitude of this required holding force, a downslope variable of the vehicle is determined, for example, from an incline of the underlying surface of the vehicle. Depending on the pedal variable, the drive variable (or, in general, the engine information), as well as the downslope variable (or the holding force), a distribution of the braking force between the first and the second brake arrangement is subsequently determined and controlled accordingly.

This application claims priority under 35 U.S.C. § 119 to patent application no. DE 10 2025 101 804.9, filed on Jan. 20, 2025 in Germany, the disclosure of which is incorporated herein by reference in its entirety.

The disclosure relates to a method and a device for controlling the braking force on a

vehicle, in particular, on an incline.

### BACKGROUND

To secure the vehicle during standstill, a parking brake is typically provided, which may

be actuated independently of a service brake. The parking brake is released as soon as it is detected that the vehicle is ready to drive, the driver has actuated the accelerator pedal, and thus an unambiguous intention to drive off is present. In the subsequent drive-off operation, for the release operation of the parking brake, a force balance is established between the corresponding downslope force and the provided driving force. If the driving force exceeds the current downslope force, a release of the parking brake is initiated, such that the vehicle may start moving.

However, in the case of steep inclines as well as rapid actuation of the accelerator pedal, it may occur during a drive-off operation that the driving force is built up more quickly than the braking force at the parking brake is reduced. In this case, when driving off on a incline, it may occur that a braking effect of the parking brake is still present, even though the vehicle engine has already built up sufficient drive torque to move the vehicle. The driver perceives this situation as a brief drive-off against the still-activated parking brake.

From document DE 10 2005 027 843 A1, it is known to hold the vehicle on a slope by way of a parking brake. When driving off on an inclined gradient, the service brake is first activated, subsequently the parking brake is released, before the drive is acted upon with a torque. Subsequently, the service brake is released again in order to enable a controlled drive-off.

With the present disclosure, a solution is presented for distributing the braking force required at the wheels to hold the vehicle among the available brakes.

### SUMMARY

According to the present disclosure, a method and a device for controlling the brake-force distribution between a first and a second brake arrangement of a vehicle are described below. In this context, a pedal variable representing actuation of the accelerator pedal is detected. For example, this pedal variable may be the pedal position, the speed of pedal actuation, or the force applied to the pedal. Furthermore, a drive variable is detected, which represents the driving force of the engine. By way of this drive variable it is detected whether the vehicle is ready for a drive-off operation. In this context, engine information may be detected as the drive variable, which represents the drive torque and/or gear information. In order to determine the extent to which establishment of a holding force for the vehicle is required, or the magnitude of this required holding force, a downslope variable of the vehicle is determined, for example, from an incline of the underlying surface of the vehicle. The holding force may additionally be determined taking into account the load and/or the vehicle mass. Depending on the pedal variable, the drive variable (or, in general, the engine information), as well as the downslope variable (or the holding force), a distribution of the braking force between the first and the second brake arrangement is subsequently determined and controlled accordingly.

The advantage of the disclosed method is that both brake arrangements may contribute, with their respective advantages, to generating the holding force and to the drive-off operation. Thus, for example, a brake arrangement that is otherwise slow-responding may be supplemented and/or compensated by a more highly dynamic brake arrangement in order to make the drive-off operation more comfortable for the driver.

In a development of the disclosure, it is provided that the pedal variable and/or a pedal-change variable derived from the pedal variable is compared with a threshold value, and the brake-force distribution is controlled as a function of this comparison. By taking this into account, the brake-force distribution according to the disclosure may, for example, be activated only in particular situations in which the driver desires a rapid drive-off. In contrast, in the case of normal actuation of the accelerator pedal, no brake-force distribution according to the disclosure is activated. Advantageously, the threshold value may be adapted, for example, as a function of the incline of the underlying surface, the required holding force, and/or the downslope variable.

The brake-force distribution according to the disclosure may result in the braking force of the first brake arrangement being increased, while the braking effect of the second brake arrangement is reduced. This change may also be carried out in steps, for example, as a function of the detected pedal variable and/or the drive variable. It is also conceivable that, at the beginning of the method, essentially the second brake arrangement is activated and provides the entire braking force, or at least the predominant portion of the total braking force, of the vehicle in this situation. During the brake-force distribution, the braking-force portion of the first brake arrangement may then be reduced more slowly than the braking force of the second brake arrangement.

The disclosure may be used particularly advantageously when the vehicle drives off from standstill and/or on an incline. In this context, it may, in particular, be provided that the total braking force is initially generated essentially by the second brake arrangement.

Furthermore, it may be provided that the total braking force is controlled as a function of the pedal variable. Thus, in the event of an increase in the pedal variable, for example, due to rapid and/or forceful actuation, it may be assumed that the driver wishes to drive off quickly, such that the total braking force is reduced.

In the device according to the disclosure, it may be provided that a control unit carries out the method according to the disclosure and controls both the first and the second brake arrangement. In this context, the first brake arrangement may be a service brake and the second brake arrangement may be a parking brake or park brake. It is also conceivable that the first brake arrangement has a higher dynamic response in the build-up and/or reduction of the braking force than the second brake arrangement. In this case, by way of a suitable distribution of the braking force to both brake arrangements, a rapid response to a changed drive-off condition may be achieved without the driver experiencing any reduction in comfort. Thus, a comfortable and as jerk-free as possible drive-off out of the parking brake is enabled for the driver.

In a development, it may also be provided that a central control unit determines the requirement for the brake-force distribution and, subsequently, separate control devices actuate the first and the second brake arrangement. These separate first and second control devices may then implement the control commands for generating the braking force, respectively for reducing the braking force. Alternatively, the two control devices may also exchange information with one another, with the aid of which they autonomously regulate the brake-force distribution at the brake arrangements assigned to them in accordance with the specifications of the central control unit.

### BRIEF DESCRIPTION OF THE DRAWINGS

In FIG. 1, the braking behavior during drive-off of a vehicle is shown by way of a diagram.

In FIG. 2, the effect of the method according to the disclosure on the braking behavior is shown.

FIG. 3 shows a block diagram of the application of the method according to the disclosure, which is shown, by way of example, as a flow diagram in FIG. 4.

### DETAILED DESCRIPTION

For vehicles that have been parked, it is often provided that the existing parking brake and/or park brake is activated in order to prevent the vehicle from rolling away, in particular, on a slope. Once the driver wishes to drive off, the braking force applied by the parking brake must be reduced, such that the vehicle may be set in motion. However, if the vehicle is located on a slope or if the underlying surface of the vehicle has a incline, the parking brake or the park brake holds the vehicle until sufficient drive torque has been built up to compensate the downslope force. This behavior is graphically illustrated in the diagram of FIG. 1.

At time t0, the parking brake in the example of FIG. 1 exhibits a maximum braking force effect 20, or a maximum clamping force of 100%. After the driver has depressed the accelerator pedal for drive-off, the driving force 10 is built up. If the actuation of the accelerator pedal increases, for example, due to more rapid actuation or a greater actuation force, the driving-force gradient likewise increases, as is apparent at time t1. At time t2, the driving force reaches the braking or holding force generated by the parking brake, such that the vehicle may move away from standstill without, for example, rolling back on a slope. At this time t2, the desire to drive off may therefore be detected, such that the parking brake may be released. Due to the normally sluggish behavior of the parking brake, which, in contrast to the service brake, is not designed for rapid reactions, the release of the brake may occur only at a later time t3, and thus the reduction of the braking force may take place until time t4. Between time t2 and t3, in particular, but also until the clamping force applied by the parking brake has been completely reduced, the driver may notice a brief drive-off against the still-present braking force. With the present disclosure, this is prevented, as will be explained in the following example, with reference to FIG. 2.

Also in the example of FIG. 2, the parking brake initially exhibits a maximum braking force 20 or clamping force. As soon as the desire to drive off is detected at time t0, for example, as a function of the pedal actuation, the service brake may be activated, such that it likewise builds up a braking force 30. As soon as the braking force of the service brake likewise reaches its maximum or a predefined value at time t1, the release of the parking brake, and thus the reduction of the braking force by the parking brake, may be initiated. Furthermore, it can be seen in FIG. 2 that the driving force 10 increases after the (initial) actuation of the accelerator pedal. If the accelerator pedal actuation changes, for example, by more rapid actuation or stronger pressure on the accelerator pedal, as shown at time t2, the driving force likewise increases with a higher gradient. Due to the higher dynamics of the service brake, it may be used at this time t2 to reduce braking force more rapidly, such that a resulting total braking force formed by the service brake and the parking brake, which is still partially contributing at this time, is reduced. In the present example, the braking force of the parking brake is linearly reduced at time t1 until it is completely reduced at time t3. In contrast, the braking force of the more dynamic service brake will be completely reduced at a later time t4, such that the vehicle may move forward.

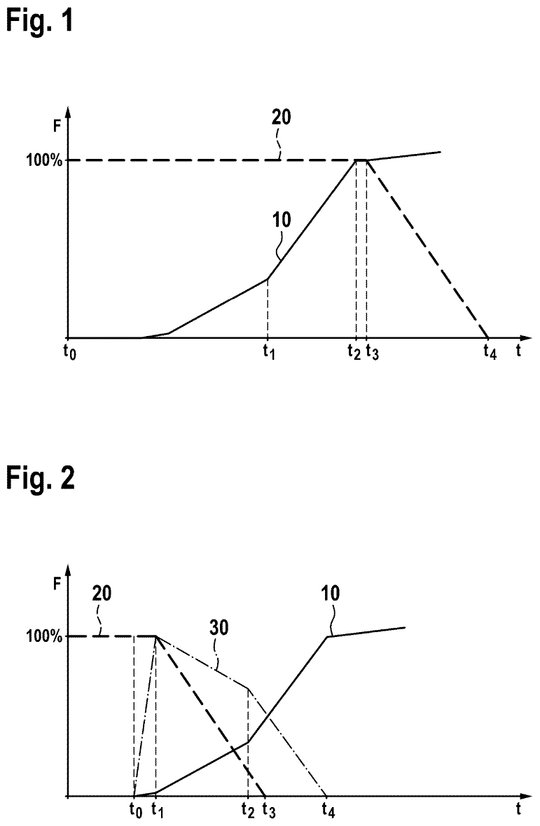

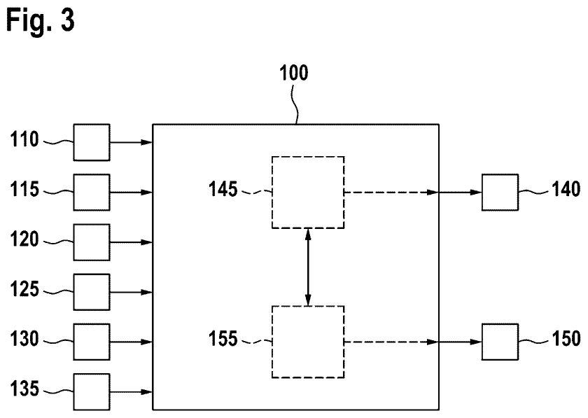

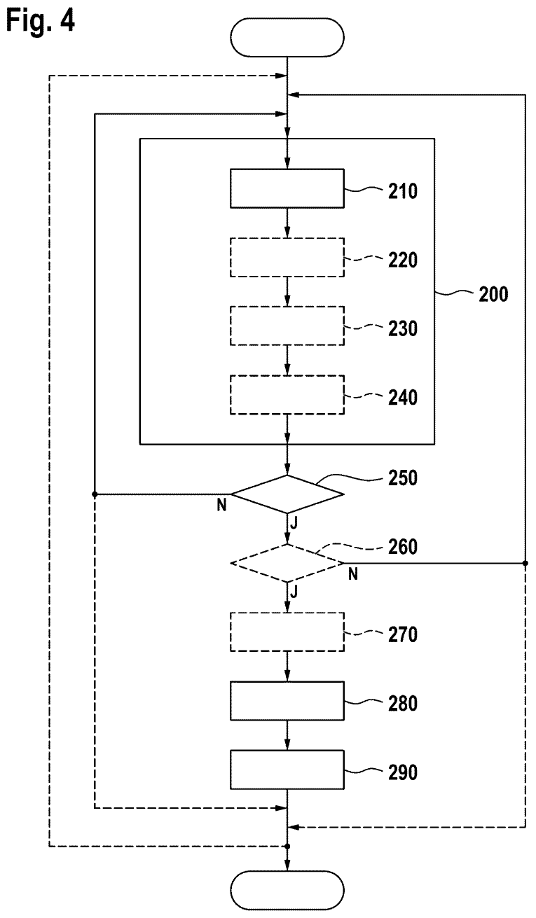

FIG. 3 shows a block diagram illustrating a possible implementation of a device which implements a method for brake-force distribution according to the present disclosure. In this context, a central control unit 100 is provided, which controls or regulates a first brake arrangement 140, for example, a service brake, and a second brake arrangement 150, for example, a parking brake and/or a park brake. Alternatively, the control unit 100 may also be a separate first control device 145 for controlling or regulating the first brake arrangement 140 and a second control device 155 for controlling or regulating the second brake arrangement 150. Optionally, it may be provided that the first and the second control device additionally exchange information in order, after the initial control or activation by the central control unit 100, to distribute the braking force largely autonomously to the two brake arrangements 140 and 150. In this context, the control devices 145 and 155 may autonomously and/or automatically detect the variables and parameters required for the brake-force distribution.

For determining the brake-force distribution and, in particular, for deriving the control of the brake arrangements, the control unit 100 detects pedal variables of the accelerator pedal 110, which represent the actuation and, in particular, the actuation dynamics. As pedal variables, pedal positions, actuation speeds, and/or actuation forces may be detected. Furthermore, the control unit detects at least one engine information, for example, the engaged gear 115, the present driving force 120, and/or another engine information 130 which represents the drive torque. To determine the required holding force for the vehicle, the control unit may detect the longitudinal acceleration 125 of the vehicle in order to determine the present incline therefrom. Alternatively, the incline may also be detected directly by a corresponding sensor 135. By way of the incline, the downslope force may subsequently be determined and, therefrom, the required holding force or the necessary (total) braking force may be derived.

Using the pedal variable, the control unit 100 subsequently detects the desire to drive off and initiates at least a partial redistribution of the braking force from the second brake arrangement 150 to the first brake arrangement 140. In this context, in addition to the pedal actuation detected by the pedal variable, the driving force resulting from the engine as well as the required holding force for the vehicle, in particular, on an ascent, are taken into account.

The control unit 100 may be part of a braking system or itself be a device for brake control. Alternatively, it may also be implemented independently of brake control, for example, as part of a control device for another vehicle component. By the control unit 100 optionally performing corresponding activations of the actual brake control devices 145 and 155, the control unit 100 may, for example, be arranged in an airbag control unit, in a car multimedia control unit, or in another control component. Furthermore, the control unit 100 may be configured as a force controller.

As the first and second brake arrangements, a hydraulic and/or an electromechanical brake system may be provided in each case. Advantageously, the first brake arrangement is used as a service brake and the second brake arrangement is used as a parking brake or a park brake.

A possible exemplary embodiment of the method according to the disclosure is illustrated by way of a flow diagram in FIG. 4. The method may be started when a drive-off situation of the vehicle is detected or predicted. Thus, for example, opening the driver door, actuating a key, and/or actuating the brake and/or accelerator pedal may initiate the method. As a prerequisite for activating the method, the condition may additionally be present that the vehicle is held essentially in its parking position by the parking brake and/or the park brake, for example, in a parking situation on an incline.

After the method is started, a pedal variable is detected in a step 210, which represents the actuation, the position, and/or the change of actuation of an accelerator pedal. Optionally, this pedal variable may also be permanently made available to the method for evaluation by a separate method. In an additional embodiment, further variables may be detected, which may be used both for determining the drive-off condition and for determining the brake-force distribution. Thus, in a step 220, engine information may be detected which represents the generated driving force. In this context, for example, a drive variable, a drive torque, and/or the engaged gear may be detected. In a step 230, the longitudinal acceleration of the vehicle may be detected, from which the incline on which the vehicle is located can be derived. Alternatively, in a step 240, the incline may be detected directly, for example, by way of an inclination sensor. Steps 210 to 240 may be carried out individually, in any order, separately, or in a common step 200.

Subsequently, in a step 250, it is checked whether the pedal variable exceeds a threshold value. This comparison serves to detect a situation in which the braking force initially applied essentially by the parking brake is to be compensated by the service brake. Thus, the threshold value may be defined, for example, such that activation of the brake-force distribution is initiated in the event of rapid actuation of the accelerator pedal, upon exceeding a pedal position, in the event of a large actuation force and/or upon a change in actuation, in particular, an increase. Optionally, the threshold value may also be adapted, for example, to the detected or determined incline, the longitudinal acceleration, the present braking force, and/or the mass or loading of the vehicle. If it is detected in step 250 that the pedal variable does not (yet) exceed the predefined threshold value, the method may be run through again starting with step 200 or step 210 in order to detect a further pedal variable. Alternatively, the method may also be ended and restarted at a later point in time.

As explained at the outset, the method according to the disclosure may be started when a drive-off condition is present. Alternatively, this drive-off condition may be checked in an optional further step 260. For this purpose, the engine information relating to the driving force, the drive torque, and/or the gear detected in step 220 may be used. Alternatively, this engine information may also only be detected in step 260. If it is detected in step 260 that no drive-off condition is present, for example, because there is no sufficient driving force to move the vehicle, the method may be run through again starting with steps 200 or 210 or may be terminated. A renewed detection of the pedal variable in step 210 or of the engine information in step 220 may, for example, be indicated if the drive has not yet built up sufficient drive torque to move the vehicle. In this case, re-running steps 200 to 250 may provide sufficient time to build up the required driving force.

Optionally, the longitudinal acceleration of the vehicle and/or directly the incline of the underlying surface on which the vehicle is located may be detected in a further step 270 instead of in steps 230 and/or 240.

The longitudinal acceleration detected in this way or the incline derived therefrom or directly detected is used in the subsequent step 280 to determine a downslope variable, from which the necessary holding force or braking force for the vehicle is derived. Optionally, the variables detected in step 270 may also be detected jointly in step 280.

Subsequently, in step 290, a brake-force distribution between the service brake and the parking brake is initiated by releasing the parking brake and initially compensating the braking force reduced thereby by the service brake. By subsequently reducing the braking force by the service brake, the vehicle is enabled to move when a sufficient driving force is reached which exceeds the holding force. Optionally, both the reduction of the braking force at the parking brake and at the service brake may be provided with a linear reduction of the braking force.

In an embodiment of the disclosure, it may be provided that the control method additionally detects further pedal variables and/or engine information, in particular, driving forces or drive torques, in order to control the reduction of the braking force at the service brake and/or the parking brake as a function thereof. Optionally, it may also be provided that, after controlling the two brake arrangements in step 290, the method is run through again starting with steps 200 to 280 in order to detect and be able to take into account the necessary variables and/or changes thereof.

Optionally, step 290 may be provided merely for initiating the brake-force distribution between the parking brake and the service brake. Thus, a corresponding control command may be sent to the control devices of the service brake and the parking brake, which in turn then perform an adjustment of the braking force or the total braking force as a function of the detection of the pedal variable, the engine information, and/or the longitudinal acceleration. For this purpose, the two control devices may also exchange information, for example, in order to coordinate the adjustment of the braking forces at both brakes step by step.

Alternatively, in step 290, the further control of the brake-force distribution may be transferred to a separate controller, which in turn detects all necessary variables and parameters for controlling the braking force at the service brake and the parking brake or park brake.

What is claimed is:

1. A method for controlling brake-force distribution between a first brake arrangement and a second brake arrangement, comprising:
detecting a pedal variable which represents actuation of an accelerator pedal;
detecting a drive variable which represents driving force of an engine of a vehicle;
determining a downslope variable of the vehicle; and
controlling the brake-force distribution between the first brake arrangement and the second brake arrangement as a function of the pedal variable, the drive variable, and the downslope variable.

2. The method according to claim 1, wherein the controlling step includes comparing the pedal variable and/or a pedal-change variable derived from the pedal variable with a threshold value and controlling the brake-force distribution as a function of the comparison.

3. The method according to claim 1, further comprising increasing braking effect of the first brake arrangement and reducing braking effect of the second brake arrangement as a function of the drive variable and the downslope variable.

4. The method according to claim 1, further comprising initiating the method when the vehicle is at standstill or in a drive-off operation.

5. The method according to claim 1, further comprising controlling total braking force of the first brake arrangement and second brake arrangement as a function of the pedal variable.

6. The method according to claim 1, wherein the drive variable includes:
a drive torque and/or
a gear information.

7. A device for controlling brake-force distribution between a first brake arrangement and a second brake arrangement according to the method of claim 1, comprising a control unit configured to:
detect a pedal variable representing actuation of an accelerator pedal,
detect a drive variable representing driving force of an engine of a vehicle,
determine a downslope-force variable of the vehicle, and
control the brake-force distribution between the first brake arrangement and the second brake arrangement as a function of the pedal variable, the drive variable, and the downslope-force variable.

8. The device according to claim 7, wherein:
the control unit includes a brake-force control unit, and/or
the first brake arrangement includes a service brake, and/or
the second brake arrangement includes a parking brake.

9. The device according to claim 7, wherein dynamics of brake-force buildup and/or of brake-force buildup at the first brake arrangement are higher than at the second brake arrangement.

10. The device according to claim 7, wherein the control unit is further configured to actuate (i) a first control device which regulates braking force in the first brake arrangement, and (ii) a second control device which regulates braking force in the second brake arrangement.

11. The method according to claim 2, wherein the threshold value is specified as a function of an incline of an underlying surface on which the vehicle is located and/or the downslope variable.

12. The method according to claim 4, wherein when the vehicle is at standstill or in the drive-off operation, braking effect of the vehicle is generated substantially by the second brake arrangement.

13. The method according to claim 5, wherein when the pedal variable increases, a reduction of the total braking force takes place.

14. The device according to claim 10, wherein the first control device and the second control device are configured to exchange information relating to regulated braking forces at the first brake arrangement and the second brake arrangement for regulating the respective braking forces.
